(19) United States
(12) Patent Application Publication
(10) Pub. No.: US 2007/0130274 A1
(43) Pub. Date: Jun. 7, 2007

(54) Multimedia messaging automatic reply service method and system

(75) Inventors: Kyung-Tak Lee, Yongin-si (KR); Wuk Kim, Gwacheon-si (KR); Sang-Kyung Sung, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/634,600

(22) Filed: Dec. 6, 2006

(30) Foreign Application Priority Data
Dec. 6, 2005 (KR) 2005-118320

(51) Int. Cl. G06F 15/16

(52) U.S. Cl. 709/206

(57) ABSTRACT

Provided is a multimedia messaging automatic reply service method and system. The method includes in a multimedia messaging service relay/server, storing and setting an automatic reply message in response to a request for setting the automatic reply message from a predetermined mobile communication terminal; and in the multimedia messaging service relay/server, upon reception of a multimedia message to be transmitted to the predetermined mobile communication terminal, comparing transmission conditions each set to at least one or more automatic reply message, which is set in response to the request of the predetermined mobile communication terminal, with a sender and a priority of the received multimedia message, and selecting and transmitting one automatic reply message to the multimedia message sender.

### PRIORITY

This application claims priority under 35 U.S.C. § 119 to an application entitled “Multimedia Messaging Automatic Reply Service Method and System” filed in the Korean Intellectual Property Office on Dec. 6, 2005 and assigned Serial No. 2005-118320, the contents of which are incorporated herein by reference.

### BACKGROUND OF THE INVENTION

1. Field of the Invention

The present invention relates generally to a multimedia messaging service, and in particular, to a method and system for transmitting an automatic reply message related to a multimedia message.

2. Description of the Related Art

Today, a messaging service provided by a mobile communication system is providing not only a small capacity text message, but also a large capacity text message or a multimedia message having contents such as an audio, an image, and a moving picture. The messaging service providing the message including the contents can be exemplified as a Multimedia Messaging Service (MMS). The messaging service continues to be improved as a service to increase user's convenience and satisfaction.

A multimedia messaging system includes a plurality of mobile communication terminals, one or more MMS relay/servers, and a plurality of Multimedia Messaging (MM) boxes connecting with the MMS relay/servers, respectively. A transaction process for conventional multimedia message transmission and reception in the multimedia messaging system is shown in FIG. 1. FIG. 1 is a ladder diagram illustrating a message flow during transmission of the conventional multimedia message.

Referring to FIG. 1, in Step 201, a first mobile communication terminal 1 transmits a predetermined multimedia message included in an MM1_submit.REQ message, and requests a first MMS relay/server 5 to transmit the predetermined multimedia message to a second mobile communication terminal 3. In Step 203, in response to the MM1_submit.REQ message, the first MMS relay/server 5 transmits an MM1_submit.RES message to the first mobile communication terminal 1 and notifies the first mobile communication terminal 1 that multimedia message transmission is accepted, and then proceeds to Step 205. In Step 205, the first MMS relay/server 5 transmits an MM4_forward.REQ message including a predetermined multimedia message, to a second MMS relay/server 7 connecting with a second mobile communication terminal 3, and requests the second MMS relay/server 7 to transmit the multimedia message. In Step 207, in response to the transmission, the second MMS relay/server 7 transmits an MM4_forward.RES message. In Step 209, the second MMS relay/server 7 notifies the second mobile communication terminal 3 of the transmission of a multimedia message for reception, using an MM1_notification.REQ message. In Step 211, in response to the notification, the second mobile communication terminal 3 transmits an MM I_notification.RES message and in Step 213, it transmits an MM1_retrieve.REQ message to transmit a request for the multimedia message to the second MMS relay/server 7. In Step 215, the second MMS relay/server 7 transmits the request message to the second mobile communication terminal 3 using an MM1_retrieve.RES message. In Step 217, the second mobile communication terminal 3 receiving the message responds and transmits an MM1_acknowledgement.REQ message to the second MMS relay/server 7.

For example, during a vacation, a user may not use the mobile communication terminal, or may suspend a multimedia messaging service. However, during this period a multimedia message can still be transmitted to the user. Thus, the user, who intends to temporarily stop the multimedia messaging service, desires that a fact of his/her absence be well known to different users. However, a guidance or automatic reply service in absence related to the multimedia messaging service is not being provided.

Furthermore, if an automatic reply based on a single content or format is set irrespective of a sender, this method does not consider various human relationships between communicating parties, for example, human relationships such as a family, a friend, and a fellow and thus, a user's desire for setting the automatic reply cannot be sufficiently satisfied. In particular, although the message can be expressed, due to the development of the messaging service, in various formats including an image, a moving picture, and a text, a single content or format limits the type of user accessible service for setting a message of informing the absence of the user.

Thus, a multimedia messaging automatic reply method considering various relationships between a multimedia message sender and a multimedia message receiver together with various expression formats representing in-absence of the multimedia message receiver is being required. The multimedia messaging automatic reply method should be provided considering the following points.

In contrast with previous services such as a short message service, MMS transmission is much more expensive. In viewpoint of business, whenever the automatic reply is transmitted, the MMS user requesting for it will naturally pay a cost. Thus, in order to minimize the cost, the MMS user prefers having much versatility depending on circumstances. Accordingly, the MMS user can decide the times or when to transmit the automatic reply.

Depending on the type of mobile communication terminal, it may not play the moving picture or display the image. Due to the diversity of the mobile communication terminal, transmission of the automatic reply comprised of the moving picture to the mobile communication terminal that cannot play the moving picture can result in a cost waste for the user setting the automatic reply, and can cause the user receiving the automatic reply to feel unpleasant for an unidentifiable message.

Accordingly, a multimedia messaging automatic reply method considering the above described drawback is desired.

### SUMMARY OF THE INVENTION

It is, therefore, an object of the present invention to provide a multimedia messaging automatic reply service method and system for providing automatic reply setting related to a multimedia messaging service.

It is another object of the present invention to provide a multimedia messaging automatic reply service method and system for providing an automatic reply message based on various formats.

It is a further object of the present invention to provide a multimedia messaging automatic reply service method and system for providing an automatic reply message of a different kind depending on relationships between multimedia message sender and receiver.

In order to achieve the above and other objects, there is provided a method for a multimedia messaging automatic reply service. The method includes in a multimedia messaging service relay/server, storing and setting an automatic reply message in response to a request for setting the automatic reply message from a predetermined mobile communication terminal, depending on a transmission condition set to the automatic reply message received from the predetermined mobile communication terminal; and in the multimedia messaging service relay/server, upon reception of a multimedia message to be transmitted to the predetermined mobile communication terminal, comparing transmission conditions each set to one or more automatic reply messages, which are set in response to the request of the predetermined mobile communication terminal, with a sender and a priority of the received multimedia message, and selecting and transmitting one automatic reply message to the multimedia message sender, whereby, when the transmission conditions are different, one or more automatic reply messages associated with one sender are set.

In another aspect of the present invention, there is provided a method for a multimedia messaging automatic reply service. The method includes in a multimedia messaging service relay/server, storing and setting an automatic reply message depending on a transmission condition set to the automatic reply message received from a predetermined mobile communication terminal, and a kind of contents comprised in the automatic reply message, in response to a request for setting the automatic reply message from the predetermined mobile communication terminal; and in the multimedia messaging service relay/server, upon receipt of a multimedia message to be transmitted to the predetermined mobile communication terminal, comparing transmission conditions each set to one or more automatic reply messages set in response to the request of the predetermined mobile communication terminal and a kind of contents comprised therein, with a sender and a priority of the received multimedia message and a kind of contents comprised therein, and selecting and transmitting one automatic reply message to the multimedia message sender, whereby, when the transmission conditions are different, one or more automatic reply messages associated with one sender are set.

### BRIEF DESCRIPTION OF THE DRAWINGS

The above and other objects, features and advantages of the present invention will become more apparent from the following detailed description when taken in conjunction with the accompanying drawings in which:

FIG. 1 is a ladder diagram illustrating a message flow when a conventional multimedia message is transmitted;

FIG. 2 is a block diagram illustrating a construction of a multimedia messaging service system according to the present invention;

FIG. 3 is a block diagram illustrating a construction of a mobile communication terminal according to the present invention;

FIG. 4 is a flowchart illustrating an operation of a multimedia messaging service relay/server when a request for setting of an automatic reply message is received according to the present invention;

FIG. 5 is a flowchart illustrating an operation of a multimedia messaging service relay/server when a request for changing of an automatic reply message is received according to the present invention;

FIG. 6 is a flowchart illustrating an operation of a multimedia messaging service relay/server when a request for displaying an automatic reply message is received according to the present invention;

FIG. 7 is a flowchart illustrating an operation of a multimedia messaging service relay/server when a request for deletion of an automatic reply message is received according to the present invention; and

FIG. 8 is a flowchart illustrating an operation of a multimedia messaging service relay/server when an automatic reply message is transmitted according to the present invention.

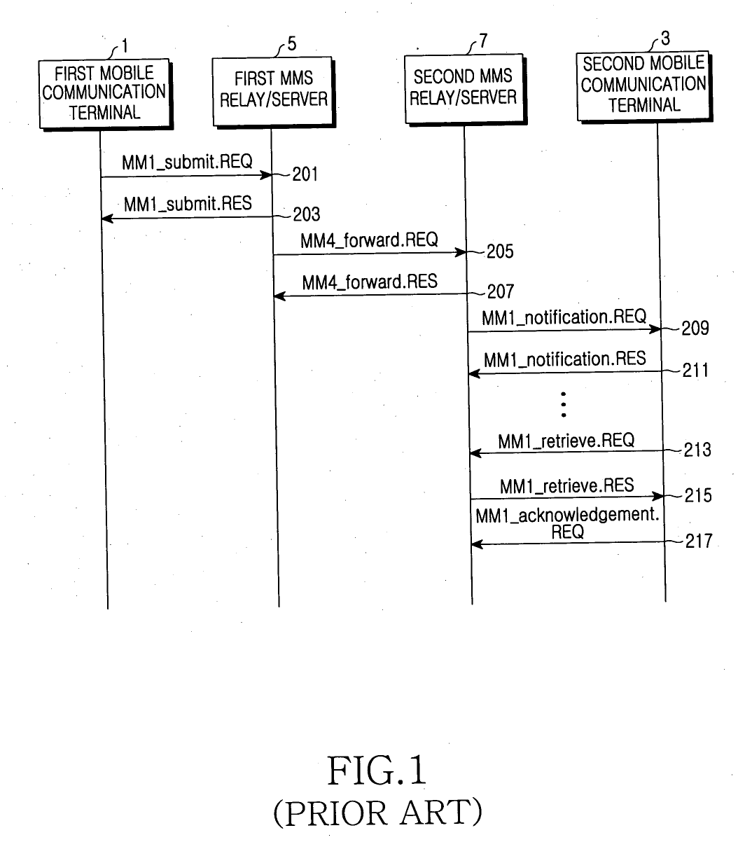

### DETAILED DESCRIPTION OF THE PREFERRED EMBODIMENT

A preferred embodiment of the present invention will now be described in detail with reference to the accompanying drawings. In the drawings, the same or similar elements are denoted by the same reference numerals even though they are depicted in different drawings. In the following description, a detailed description of known functions and configurations incorporated herein has been omitted for conciseness.

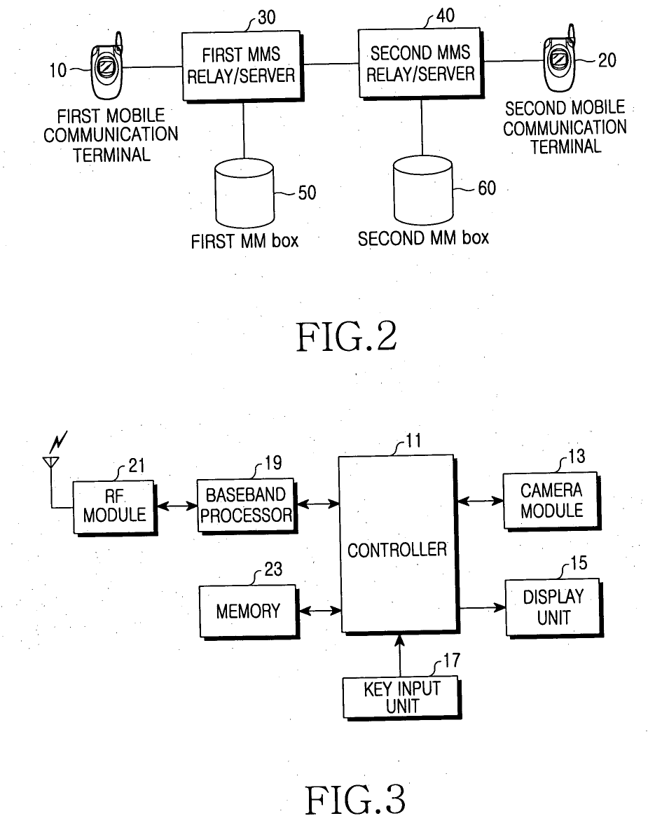

FIG. 2 is a block diagram illustrating a construction of a Multimedia Messaging Service (MMS) system according to the present invention. Referring to FIG. 2, the MMS system includes a plurality of mobile communication terminals 10 and 20, one or more MMS relay/servers 30 and 40, and one or more Multimedia Message (MM) boxes 50 and 60.

The plurality of mobile communication terminals 10 and 20 wirelessly communicate with the MMS relay/servers 30 and 40 using a mobile communication network. In response to a user's request, the plurality of mobile communication terminals 10 and 20 transmit a multimedia message, or perform an operation based on the user's request related to the management of a multimedia message stored in the MM boxes 50 and 60 according to the present invention. According to the present invention, the plurality of mobile communication terminals 10 and 20 are comprised of a first mobile communication terminal (“first terminal”) 10 and a second mobile communication terminal (“second terminal”) 20. When the mobile communication terminals 10 and 20 are not receiving the multimedia message as in the absence of a user, in response to the generated multimedia message, they can depending on user's manipulation, select and prepare an automatic reply message to be transmitted to senders of the generated multimedia message, as well as transmit the prepared automatic reply message to the MMS relay/servers 30 and 40, thereby transmitting a request for an automatic reply service for transmitting the automatic reply message. The mobile communication terminals 10 and 20 can transmit a request for changing and displaying of a transmission condition of the preset automatic reply message, and send a request for unsetting of the automatic reply message. In the present invention, it is assumed that the first terminal 10 refers to a terminal to set and manage the automatic reply message, that is, a terminal to transmit a request for the automatic reply service, and the second terminal 20 refers to a terminal to receive the automatic reply message set by the first terminal 10.

The plurality of MMS relay/servers 30 and 40 connect with the plurality of mobile communication terminals 10 and 20 through the mobile communication network, and also connect with each other through the mobile communication network, respectively. The plurality of MMS relay/servers 30 and 40 are system elements to execute the user's request related to the multimedia messaging service and at the same time, are main elements of an MMS network. Simply, the MMS relay/servers 30 and 40 manage a messaging operation, such as an electronic mail together with other MMS relay/servers as well as with other messaging systems. They also provide a message storage service. The MMS relay/servers 30 and 40 can also be separated into two constituent elements: an MMS proxy relay for a mutual operation of the mobile communication terminals 10 and 20 and other messaging systems, and an MMS server for the storage service. The plurality of MMS relay/servers 30 and 40 include a first MMS relay/server 30 and a second MMS relay/server 40. The first MMS relay/server 30 connects with the first terminal 10 through the mobile communication network, and the second MMS relay/server 40 connects with the second terminal 20 through the mobile communication network. In a detailed description of the present invention, that a predetermined mobile communication terminal connects with the MMS relay/server through the mobile communication network means that the predetermined mobile communication terminal is positioned in a service area of a predetermined messaging service server. In response to the request of the mobile communication terminals 10 and 20, the MMS relay/servers 30 and 40 set and change the automatic reply message related to the multimedia messaging service, and provide a set condition and contents, and execute deletion. Depending on a condition that is set by an automatic reply service requester, the MMS relay/servers 30 and 40 search for an optimal automatic reply message based on a priority and a sender of the received multimedia message, and transmit the optimal automatic reply message to the multimedia message sender.

The plurality of MM boxes 50 and 60, storage devices related to the MMS relay/servers 30 and 40, are used for continuous and network based message storage. The user of the mobile communication terminals can mutually operate with the MMS relay/servers 30 and 40 to manage the message stored in the MM boxes 50 and 60. The plurality of MM boxes 50 and 60 include a first MM box 50 and a second MM box 60. The first MM box 50 connects with the first MMS relay/server 30, and the second MM box 60 connects with the second MMS relay/server 40. According to the present invention, the MM boxes 50 and 60 can be constructed to store the automatic reply message and the transmission condition associated with the automatic reply message, respectively. In the present invention, the MM relay/servers 30 and 40 can also be constructed to store the automatic reply message and the transmission condition associated with the automatic reply message, respectively.

A detailed construction of the mobile communication terminal in the above constructed multimedia messaging system according to the present invention is illustrated in FIG. 3. FIG. 3 is a block diagram illustrating the construction of the mobile communication terminal according to the present invention. The construction is applied to all of the first terminal 10 and the second terminal 20.

Referring to FIG. 3, the mobile communication terminal includes a controller 11, a camera module 13, a display unit 15, a key input unit 17, a baseband processor 19, a Radio Frequency (RF) module 21, and a memory 23.

The camera module 13 outputs an image frame obtained by an image sensor (not shown).

The display unit 15 displays a variety of image information and data information, which are received from a base station (BS) or stored in the memory 23, on a screen under the control of the controller 11.

The key input unit 17 includes numeric keys of 0 to 9, * and # keys, direction keys, and a plurality of function keys such as Menu, Option, Cancel, Power on/off, and Volume keys associated with various functions of the mobile communication terminal. The key input unit 17 provides key input data associated with keys pressed by the user, to the controller 11.

The RF module 21 communicates a wireless signal with a mobile communication BS through an antenna. The RF module 21 receives an RF signal from the controller 11 through the baseband processor 19, modulates the RF signal to be transmitted, and transmits the modulated RF signal through the antenna. The RF module 21 demodulates an RF signal received through the antenna, and provides the demodulated RF signal to the controller 11 through the baseband processor 19. The baseband processor 19 processes a baseband signal communicated between the RF module 21 and the controller 11.

The memory 23 stores program for process and control of the controller 11, including reference data, a variety of updateable storage data, a plurality of user automatic reply messages, and a plurality of default automatic reply messages, and provides them to a working memory of the controller 11. According to the present invention, the memory 23 stores program data related to automatic reply message preparing, transmission condition setting, automatic reply setting request, transmission condition changing, viewing request, and automatic reply message unsetting request.

The user automatic reply message is an automatic reply message prepared in response to the user's request. Its contents includes a short text, a large capacity text, an image, a moving picture, a flash animation, and a voice according to user's selection. The contents are prepared through user's photograph or character input, voice file record, and animation edition.

The default automatic reply message is an automatic reply message previously stored in the mobile communication terminal. Its contents includes a short text, a large capacity text, an image, a moving picture, a flash animation, and a voice. The transmission condition is associated with receivers to receive the automatic reply message to be set, that is, with the multimedia message senders, and includes sender address, priority, time limit, and receiver address.

The sender address refers to a condition that is comprised of a list of addresses of at least one sender transmitting the multimedia message to at least one receiver for receiving a predetermined automatic reply message, that is, to the automatic reply service requester. The user can designate the sender's address for a specific object. The sender address can be set for all the multimedia message senders if it is not being designated. The sender address not being specified, it is determined, depending on a different transmission condition, whether the automatic reply message is transmitted.

The priority is set to the automatic reply message depending on the user's selection, and is a basis for determining whether the automatic reply message is transmitted in relation to the priority of the multimedia message. The priority being set as a specific priority, it is allowed to transmit the automatic reply message in association with the multimedia message having the same priority. The priority can include high, normal, and low. The priority is selectively set. Where, the priority has not been set, the priority of the multimedia message has no influence when it is determined whether the automatic reply message is transmitted.

The time limit is a condition for a period in which the automatic reply service is effectively executed in relation to the automatic reply message. The receiver address is an address of an object to receive the multimedia message, that is, the automatic reply service requester. The present invention can adjust a set value of the transmission condition, and set a plurality of automatic reply messages to one multimedia message sender.

In the present invention, the mobile communication terminal transmits the transmission condition, and the multimedia message selected or prepared by the user, together with the request for the setting of the automatic reply message, to the MMS relay/servers 30 and 40, thereby transmitting the request for the setting of the automatic reply message and the request for the automatic reply service. In response to the request, the MMS relay/servers 30 and 40 store the automatic reply message, set the automatic reply based on the transmission condition, and transmit the automatic reply setting result and a storage position of the automatic reply message to the mobile communication terminal.

According to the present invention, the mobile communication terminal transmits position information of the automatic reply message whose transmission condition is to be changed, together with the request for the change of the automatic reply message, to the MMS relay/servers 30 and 40, depending on the user's selection, and transmits the request for the change of the transmission condition of the preset automatic reply message. In response to the request, the MMS relay/servers 30 and 40 search for the automatic reply message, change the transmission condition, and transmit a result thereof to the mobile communication terminal.

According to the present invention, the mobile communication terminal transmits the request for the display of the automatic reply message to the MMS relay/servers 30 and 40 depending on the user's selection. In response to the request, the MMS relay/servers 30 and 40 search for and transmit the transmission condition of the automatic reply message and the contents constituting the automatic reply message, to the mobile communication terminal.

According to an the present invention, depending on the user's selection, the mobile communication terminal transmits the storage position of the automatic reply message to be deleted, together with the request for the deletion of the automatic reply message, to the MMS relay/servers 30 and 40. In response to the request, the MMS relay/servers 30 and 40 delete the automatic reply message, unset the automatic reply service, and transmit a result thereof to the mobile communication terminal.

Transaction, which is related to the setting, changing, and unsetting of the automatic reply service, between the mobile communication terminal and the MMS relay/servers 30 and 40 is newly defined as an automatic reply transaction according to the present invention. The automatic reply transaction can include an MM1_auto_reply.REQ message that is an automatic reply request message, and an MM1_auto_reply.RES message that is an automatic reply request response message. The MM1_auto_reply.REQ message, a message transmitted to the MMS relay/servers 30 and 40 from the mobile communication terminal, gets different in type and set value of its including information, depending on a type of an automatic reply message related request of the mobile communication terminal. The MM1_auto_reply.RES message is a message transmitted to the mobile communication terminal from the MMS relay/servers 30 and 40 in response to the MM1_auto_reply.REQ message. The MM1_auto_reply.RES message includes a result value of the request, and gets different in kind and set value of its including information, depending on the type of the automatic reply message related request of the mobile communication terminal.

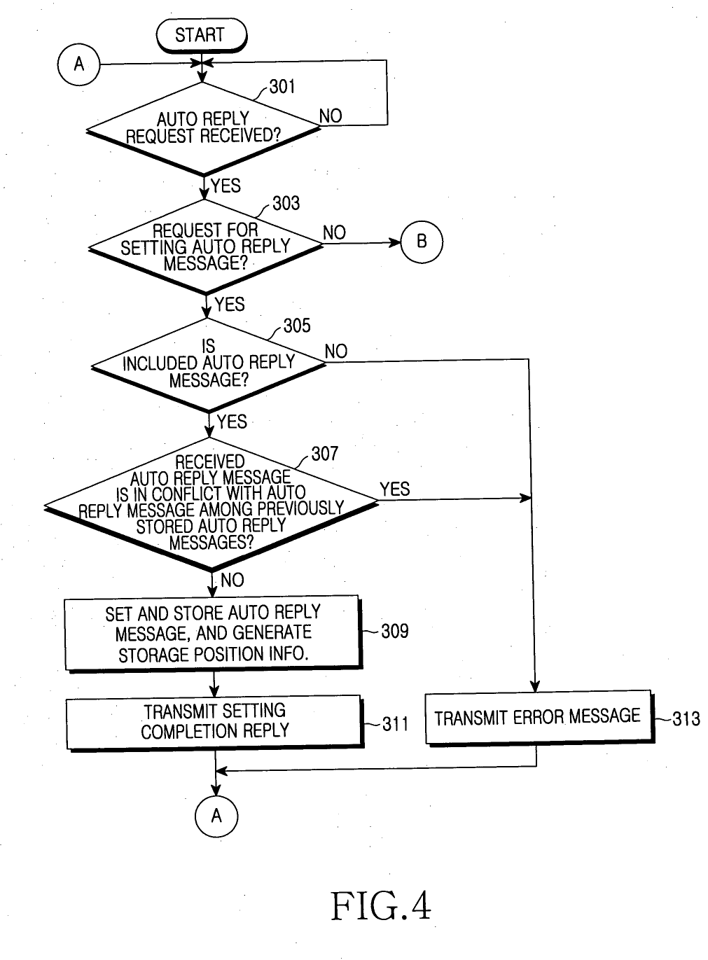

According to the present invention, an operation of the MMS relay/servers 30 and 40 depending on a process of the automatic reply message setting, transmission condition changing, viewing, and deleting, and a construction of the transaction will be described with reference to FIGS. 4 to 7 herein below.

First, a description of an operation of the mobile communication terminal and the MMS relay/servers 30 and 40 and a construction of the transaction when a new automatic reply message is set will be described herein below.

The MM1_auto_reply.REQ message, which is transmitted from the mobile communication terminal at the time of setting the new automatic reply message, includes message type information, Transaction Identification (ID) information, MMS version information, action information, sender address information, receiver address information, priority information, and time limit information, and includes the automatic reply message prepared by the user.

The message type information is information identifying a message type, and its set value represents the automatic reply request message. The transaction ID information is information identifying a paired transaction message, and its set value is an ID identifying a transaction pair of the MM1_auto_reply.REQ message and the MM1_auto_reply.RES message. The MMS version information is version identification information of an MMS interface supported by the mobile communication terminal to transmit the request for the setting of the automatic reply message, and its set value is determined depending on a kind of the mobile communication terminal. The action information is information on action to be requested by the MM1_auto_reply.REQ message and executed by the MMS relay/servers 30 and 40, and its set value can be setting, changing, viewing, and deleting. In this case, its set value becomes the setting. The sender address information, information on the sender address of the transmission condition, is information on the address list of at least one sender transmitting the multimedia message to at least one receiver for receiving the automatic reply message, that is, to the automatic reply service requester. Its set value can be designated to an address associated with a specific object by the user. When not specified, the set value can be set to all the multimedia message senders as a default value. The receiver address information is address information of the mobile communication terminal requesting for the automatic reply service. The priority information, information on the priority of the transmission condition, refers to priority information of the automatic reply message associated with the priority of the transmitted multimedia message. Its set value can be set high, normal, and low. For example, if the priority is set high, the automatic reply message is transmitted to a multimedia message sender associated with a multimedia message with high priority, and is not transmitted for multimedia messages having other priorities. When the priority is not specified, it is determined irrespective of the priority of the multimedia message whether the automatic reply message is transmitted. The time limit information, information on time limit of the transmission condition, is information on a period for which setting information is applied to the automatic reply message. Its set value is determined by date and time depending on the user's selection. When the time limit information is not being specified, a maximal period determined by an MMS provider will be applied.

According to the present invention, the first terminal 10 prepares the above constructed MM1_auto_reply.REQ message depending on user's input, and transmits the prepared message to the MMS relay/server 30. An operation of the MMS relay/server 30 to receive the MM1_auto_reply.REQ message and set the automatic reply message is shown in FIG. 4. FIG. 4 is a flowchart illustrating the operation of the MMS relay/server 30 when the request for the setting of the automatic reply message is received according to the present invention.

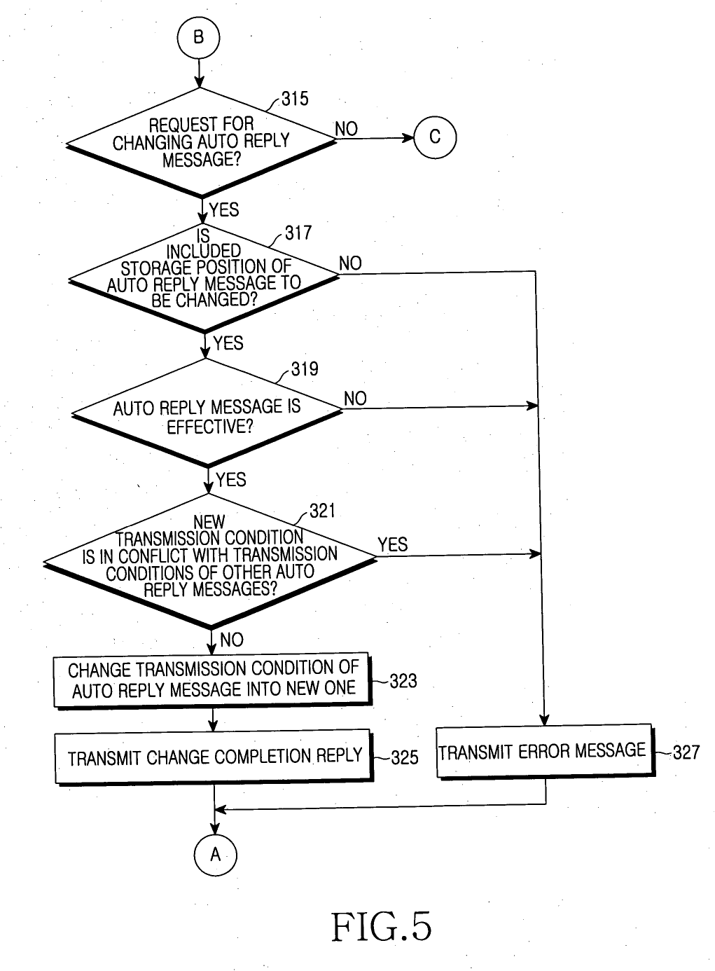

Referring to FIG. 4, in Step 301, the MMS relay/server 30 receives the MM1_auto_reply.REQ message and checks whether it receives the automatic reply request. Upon reception of the automatic reply request, the MMS relay/server 30 proceeds to Step 303, and otherwise, it delays the request in Step 301. In the Step 303, the MMS relay/server 30 checks action information value of the MM1_auto_reply.REQ message. Upon confirmation of the setting of the automatic reply message, the MMS relay/server 30 proceeds to Step 305. Otherwise, it proceeds with a process of (B) and proceeds to Step 315 of FIG. 5. In the Step 305, the MMS relay/server 30 checks whether the received MM1_auto-reply.REQ message includes the automatic reply message. If affirmative, the MMS relay/server 30 proceeds to Step 307. Otherwise, in Step 313, it includes information representing an error in the MM1_auto_reply.RES message, and transmits it to a terminal to transmit the request for the automatic reply service, that is, to the first terminal 10.

In the Step 307, the MMS relay/server 30 checks whether there exists an automatic reply message, which is in conflict with the received automatic reply message included in the MM1_auto_reply.REQ message, among the previously stored automatic reply messages. If existing, the MMS relay/server 30 transmits an error message in the Step 313, and otherwise, it proceeds to Step 309. The following is a basis for determining whether the previously stored automatic reply message is in conflict with a new automatic reply message in the Step 307.

In the present invention, the plurality of automatic reply messages can be set for one multimedia message sender under one or more transmission conditions. Thus, the MMS relay/server 30 should be such that the new automatic reply message is not in conflict with the preset other automatic reply messages. In the present invention, the conflict between two automatic reply messages means that since two automatic reply messages correspondingly set for one multimedia message are checked to have the same transmission qualification, the MMS relay/server 30 cannot determine whether it transmits any automatic reply message. Accordingly, whenever receiving a new automatic reply message setting request or transmission condition change request, the MMS relay/server 30 has to determine whether a new conflict is generated.

In the present invention, the conflict between the automatic reply messages is generated by two transmission conditions including the sender address and the priority related to the automatic reply messages. Specifically, the conflict is generated when the sender address and the priority are determined to be not many and unspecified senders or unspecified priorities, but a specific multimedia message sender or a specific priority. The following is a basis for determining whether the conflict is generated.

First, the automatic reply messages having the same sender address and the same priority are in conflict with each other. For example, when a first automatic reply message has high priority and the second terminal 20 is designated as the sender address, and a second automatic reply message has high priority and the mobile communication terminal different from the second terminal 20 is designated as the sender address, the automatic reply messages are in conflict with each other. Such a rule can be applied only to the automatic reply message for which the multimedia message sender and priority is expressively specified.

In case where any one of the multimedia message sender address and priority is not specified for the compared automatic reply messages, the following bases are applied. First, in case where the multimedia message sender address or priority is specified for the first automatic reply message, but there is none specified for the second automatic reply message, the automatic reply messages are not in conflict with each other because the first automatic reply message is an exceptional case of the second automatic reply message. For example, in case where the second terminal 20 is designated as the sender address of the first automatic reply message, and the determined multimedia message sender address is not set for the second automatic reply message, the automatic reply messages are not in conflict with each other, regardless of the set values of the priorities of the two automatic reply messages, according to the present invention. This is because, when the second terminal 20 transmits a multimedia message with a predetermined priority, the first automatic reply message can be applied as an exceptional case while, the second automatic reply message can be applied in all other cases.

Next, when any one of the sender address and the priority is not specified for any one of the automatic reply messages to be compared, the conflict is determined depending on other specified transmission conditions. For example, if the determined multimedia message sender address is not set for the first and second automatic reply messages, the conflict is determined on the basis of the set value of the priority. As an example of conflict and non-conflict, the first automatic reply message with the high priority and the second automatic reply message with normal priority are not in conflict with each other. Having a common high priority, the first automatic reply message with the high priority is in conflict with the second automatic reply message with normal and high priority. The first automatic reply message with the high priority is not in conflict with the second automatic reply message without a specific priority.

Last, when the sender address and the priority are not all specified for any one of the automatic reply messages to be compared, the automatic reply messages can be applied to all cases and thus, are in conflict with each other.

Referring again to FIG. 4, in the Step 309, the MMS relay/server 30 accepts the request for the setting of the automatic reply message from the mobile communication terminal, sets and stores the automatic reply message depending on the setting information including the automatic reply message transmission condition (e.g., the sender address information, the receiver address information, the priority information, and the time limit information), generates storage position information, and proceeds to Step 311. The storage position information can be used for future transactions of the mobile communication terminal that transmits the request for the setting of the automatic reply message. A storage position can be a temporary position designated by the MMS relay/server 30 according to the present invention, or can be a storage region of the MM boxes 50 and 60 of the mobile communication terminal that transmits the request for the setting of the automatic reply message. In the Step 311, the MMS relay/server 30 includes information representing setting completion in the MM1_auto_reply.RES message to transmit a setting completion reply to the first terminal 10. The MMS relay/server 30 proceeds with a process of (A) and thus the Step 301, and checks whether there is a new automatic reply request.

According to the present invention, in connection with new automatic reply message setting, information of the MM1_auto_reply.RES message includes message type information, transaction ID information, MMS version information, message storage position information, request result information, and request result text information.

The message type information is information identifying a message type, and its set value is the automatic reply request response. The transaction ID information is ID information identifying an MM1_auto_reply.REQ message/MM1_auto_reply.RES message transaction pair. The MMS version information is information identifying a version of an interface supported by the MMS relay/server 30. The message storage position information is storage position information on the automatic reply message successively stored. The request result information is information representing a success or failure of an operation requested by the MM1_auto_reply.REQ message transmitted from the mobile communication terminal, and its set value can be the success or failure. The request result text information is information for greater detail describing the success or failure of the operation requested by the MM1_auto_reply.REQ message transmitted from the mobile communication terminal, and its set value can be a cause of error generation in failure.

Meanwhile, in the present invention, the mobile communication terminal can be constructed to perform some operations of the MMS relay/server 30. For example, in order to clearly include the automatic reply message in the MM1_auto_reply.REQ message at the time of transmitting the request for the setting of the automatic reply message, the mobile communication terminal can be constructed to provide a guidance message of informing that the MM1_auto_reply.REQ message should necessarily include the automatic reply message. The mobile communication terminal can be constructed to determine whether the MM1_auto_reply.REQ message includes the automatic reply message before transmission, and display an error message for the user when it does not include the automatic reply message.

The mobile communication terminal can be constructed such that it can store a local copy of all the setting information of the successfully set automatic reply messages and, when there is a new automatic reply message setting request from the user, can determine whether there is a conflict with the setting information of the existing automatic reply message. Upon the detection of a new conflict, the mobile communication terminal can display the error message for the user before transmitting the MM1_auto_reply.REQ message.

Operations of the mobile communication terminal and the MMS relay/servers 30 and 40 and a construction of the transaction when the transmission condition of the preset automatic reply message is changed will be described herein below.

The preset automatic reply message being changed in its transmission condition, the mobile communication terminal transmits the MM1_auto_reply.REQ message of which the action information is set as the change and a new transmission condition for the automatic reply message to be changed is set, to the MMS relay/servers 30 and 40. The MMS relay/server processes the transmission condition change request and then, transmits the MM1_auto_reply.RES message to the mobile communication terminal, thereby notifying of a success or failure of the change request.

Information element included in the MM1_auto_reply.REQ message transmitted at the time of changing the transmission condition of the preset automatic reply message is message type information, transaction ID information, MMS version information, action information, storage position information, sender address information, priority information, and time limit information.

The message type information, the transaction ID information, and the MMS version information have set values similar to the values set at the time of transmitting the request for the setting of the automatic reply message. A set value of the action information is set as the change. The storage position information is information on the storage position of the automatic reply message of which the transmission condition designated by the user is to be changed. The storage position information is received as included in the automatic reply message responsive to a previous automatic reply message setting request, and is stored in the mobile communication terminal. The set value of the sender address can be set as a new list of the sender address, depending on the user's selection, in connection with the automatic reply messages expressed in the storage position information. Upon the input of any predefined default value, it can be also requested not to specify the sender address. If neither a new specific sender addressnor a default value is input, then a request for a change of the sender address is not transmitted. Depending on the user's input, the priority information can be set as a list of new priorities to be set to the automatic reply message, which is expressed by the storage position information. If any predefined default value is inputted, a request for specifying the priority cannot also be transmitted. If there is neither a new priority list input nor a default value input, then a request for a change of the priority is not transmitted. Depending on the user's input, the time limit information specifies a new time limit to be set to the automatic reply message expressed by the storage position information. If a new time limit is not input, then a request for a change of the time limit information is not transmitted.

An operation of the MMS relay/server 30 receiving the above constructed MM1_auto_reply.REQ message from the first terminal 10 according to the present invention is shown in FIG. 5. FIG. 5 is a flowchart illustrating the operation of the MMS relay/server when the request for the change of the automatic reply message is received according to the present invention.

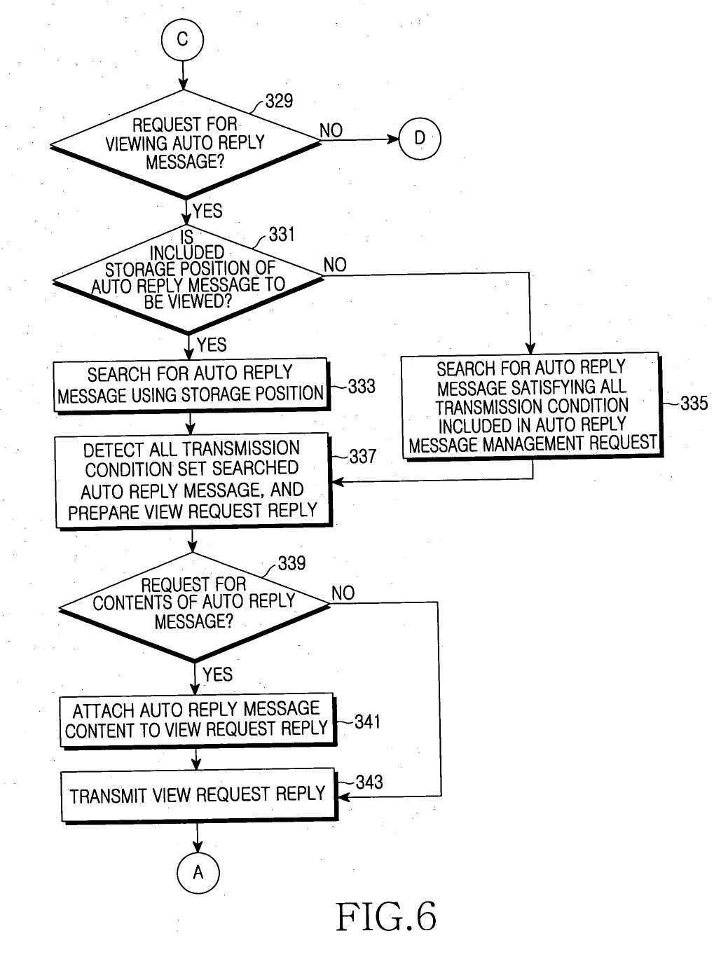

Referring to FIGS. 4 and 5, if the MMS relay/server 30 receives the MM1_auto_reply.REQ message and receives the automatic reply request in Step 301 of FIG. 4, it checks the action information in the Step 303 and, when the action information does not equal to the setting, proceeds to Step 315 of FIG. 5. In the Step 315, the MMS relay/server 30 determines whether the action information of the received MM1_auto reply.REQ message equals to the change. Simply, it determines whether the action information equals to the request for the change of the transmission condition of the preset automatic reply message. If affirmative, the MMS relay/server 30 proceeds to Step 317. Otherwise, the MMS relay/server 30 proceeds to a process of (C) and proceeds with Step 329 of FIG. 6.

In Step 317, the MMS relay/server 30 determines whether the MM1_auto_reply.REQ message includes the storage position information, that is, the storage position of the automatic reply message to change. If affirmative, the MMS relay/server 30 proceeds to Step 319 and, otherwise, proceeds to Step 327. If not including the storage position information, it means that an error is generated. Thus, the MMS relay/server 30 transmits the error message to the first terminal 10 in Step 327, and proceeds with the process of (A) and proceeds to Step 301 of FIG. 4.

In Step 319, the MMS relay/server 30 determines whether the storage position information included in the MM1_auto_reply.REQ message indicates an effective automatic reply message. If affirmative, the MMS relay/server 30 proceeds to Step 321 and, otherwise, proceeds to Step 327. In Step 321, the MMS relay/server 30 determines whether a new transmission condition included in the MM1_auto_reply.REQ message is in conflict with transmission conditions of other existing automatic reply messages. In other words, the MMS relay/server 30 determines whether the new transmission condition is in conflict with automatic reply messages different from automatic reply messages to be set. If so, the MMS relay/server 30 proceeds to Step 327 and, otherwise, proceeds to Step 323. In Step 323, the MMS relay/server 30 changes the transmission condition of the automatic reply message into the new transmission condition, and proceeds to Step 325. In Step 325, the MMS relay/server 30 includes information representing successful execution of the transmission condition change request in the MM1_auto_reply.RES message, and transmits a change completion reply to the first terminal 10. Thereafter, the MMS relay/server 30 proceeds with the process of (A) and proceeds to Step 301 of FIG. 4, and determines whether there is a new automatic reply request.

The setting information included in the MM1_auto_reply.RES message is the same in kind as the setting information included in the MM1_auto_reply.RES message transmitted in response to the automatic reply setting request. Their set values are also similar, with exception of the action information. The set value of the setting information is set as the change, and the storage position information is set as storage position information responsive to the automatic reply message whose transmission condition is modified.

In the present invention, the mobile communication terminal can be constructed to perform some operations of the MMS relay/server 30. For example, in order to clearly include the storage position information in the MM1_auto_reply.REQ message at the time of transmitting the request for the change of the transmission condition of the automatic reply message, the mobile communication terminal can be constructed to provide a guidance message for notifying that the MM1_auto reply.REQ message should necessarily include the storage position information of the automatic reply message to change the transmission condition. The mobile communication terminal can be constructed to determine whether the MM1_auto_reply.REQ message includes the storage position information before transmission, and display an error message for the user when the MM1_auto_reply.REQ message does not include the automatic reply message.

The mobile communication terminal can be constructed such that it can store a local copy of all the successfully set automatic reply setting information and, when there is a request for change of a transmission condition of a predetermined automatic reply message from the user, can determine whether there is a conflict with the setting information of the existing automatic reply message. Upon the detection of a new conflict, the mobile communication terminal can display the error message for the user before transmitting the MM1_auto_reply.REQ message.

Operations of the mobile communication terminal and the MMS relay/servers 30 and 40 and a construction of the transaction when the request for the display of the preset automatic reply message is transmitted will be described herein below.

When the request for the display of the preset automatic reply message is transmitted, the mobile communication terminal transmits the MM1_auto_reply.REQ message of which the action information is set as view and the storage position information for the automatic reply message to be viewed is set, to the MMS relay/servers 30 and 40. The MMS relay/servers 30 and 40 process the request for the view of the automatic reply message and then, transmits the MM1_auto_reply.RES message to the mobile communication terminal, thereby notifying a success or failure of the view request.

Information element included in the MM1_auto_reply.REQ message transmitted at the time of transmitting the request for the view of the preset automatic reply message is message type information, transaction ID information, MMS version information, action information, storage position information, sender address information, priority information, time limit information, and contents information.

The message type information, the transaction ID information, and the MMS version information have set values similar with the values set at the time of transmitting the request for the setting of the automatic reply message. A set value of the action information is set as the display. The storage position information includes the storage positions of at least one automatic reply message selected as the automatic reply message to be viewed by the user. If the storage position information is set, the MMS relay/servers 30 and 40 disregard the sender address information, the priority information, and the time limit information. A set value of the sender address information can be the sender address to receive the automatic reply message to be viewed depending on the user's selection. Simply, all the automatic reply messages having the priorities set as the priority information are set as the automatic reply message to be displayed. A set value of the time limit information can be a set period of the automatic reply message to be displayed depending on the user's selection. In other words, the automatic reply message having a transmission time limit shorter than a transmission time limit set as the time limit information is set as the automatic reply message to be displayed. The contents information is information representing whether to view only the transmission condition of the automatic reply message to be viewed, or to view it together with contents. If it is set, the request for the contents as well as the transmission conditions of the automatic reply messages are transmitted.

An operation of the MMS relay/server 30 receiving the above constructed MM1_auto_reply.REQ message from the first terminal 10 according to the present invention is shown in FIG. 6. FIG. 5 is a flowchart illustrating the operation of the MMS relay/server when the request for displaying of the automatic reply message is received according to the present invention.

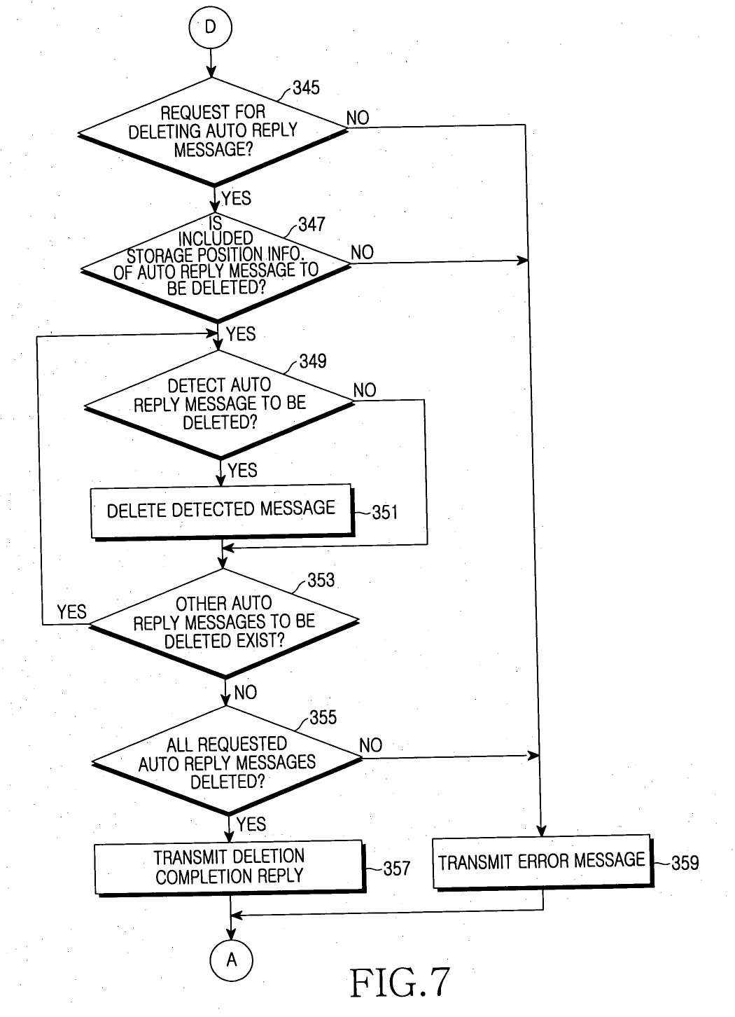

Referring to FIGS. 4 and 6, in Step 329 of FIG. 6, the MMS relay/server 30 checks the action information included in the received MM1_auto_reply.REQ message in Step 301 of FIG. 4. If the check result is the display, that is, is the automatic reply message display request, the MMS relay/server 30 proceeds to Step 331. Otherwise, the MMS relay/server 30 proceeds with a process of (D) and proceeds to Step 345 of FIG. 7. In Step 331, the MMS relay/server 30 determines whether or not the received MM1_auto_reply.REQ message includes the storage position information of the automatic reply message to be displayed. If so, the MSS relay/server 30 proceeds to Step 333 since it is meant that a request for information on a specific automatic reply message is transmitted. Otherwise, the MMS relay/server 30 proceeds to Step 335. In Step 333, the MMS relay/server 30 searches the MM box 50 for the message, using the storage position information of the automatic reply message to be displayed, and proceeds to Step 337.

In Step 335, the storage position information of the specific automatic reply message is not included. Thus, the MMS relay/server 30 searches for the automatic reply message satisfying all the transmission condition included in the received MM1_auto_reply.REQ message, and proceeds to Step 337. In Step 337, the MMS relay/server 30 detects each transmission condition for the searched automatic reply message, for example, information including the sender address and the priority, includes the detected information in the MM1_auto_reply.REQ message, prepares a reply to the view request, and proceeds to Step 339. In Step 339, the MMS relay/server 30 checks the contents information of the received MM1_auto_reply.REQ message, and determines whether or not there is a request for contents of the automatic reply message. If affirmative, the MMS relay/server 30 proceeds to Step 341 and, otherwise, proceeds to Step 343. In Step 341, the MMS relay/server 30 searches for the contents of each automatic reply message searched in Step 333 or 335, attaches the searched contents to the display request reply, and proceeds to Step 343. In Step 343, the MMS relay/server 30 transmits a view request reply message to the first terminal 10, proceeds with a process of (A), returns to Step 301, and determines whether there is any new automatic reply request.

The MM1_auto_reply.RES message is different in its format depending on whether there is the request for the contents of the automatic reply message to be displayed. The setting information included in the MM1_auto_reply.RES message are similar with the setting information included in the MM1_auto_reply.RES message at the time of the automatic reply message setting request. Among them, the set values of the sender address information, the priority information, and the time limit information are associated with the automatic reply message to be displayed. The request for the contents information being transmitted, the MM1_auto_reply.REQ message includes the contents as well as the transmission condition of each of the automatic reply message to be displayed.

Further in the present invention, the mobile communication terminal can be constructed to perform some operations of the MMS relay/server 30. For example, the mobile communication terminal can be constructed such that it can store a local copy of all the successfully set automatic reply setting information and, when there is a request for display of a predetermined automatic reply message from the user, can provide the set values of the automatic reply message matching with search bases inputted by the user. The MMS relay/servers 30 and 40 can be also constructed to transmit a request for searching for the contents of the automatic reply message when the user transmits a request for the contents of the automatic reply message.

Operations of the mobile communication terminal and the MMS relay/servers 30 and 40 and a construction of the transaction when the preset automatic reply message is deleted will be described herein below.

When the preset automatic reply message is deleted, the mobile communication terminal transmits the MM1_auto_reply.REQ message of which the action information is set as deletion and in which information on the automatic reply message to be deleted is included, to the MMS relay/servers 30 and 40. The MMS relay/servers 30 and 40 process a request for deletion of the automatic reply message and then, transmits the MM1_auto_reply.RES message to the mobile communication terminal, thereby notifying a success or failure of the deletion request.

Information element included in the MM1_auto_reply.REQ message transmitted at the time of transmitting the request for the deletion of the preset automatic reply message is message type information, transaction ID information, MMS version information, action information, and storage position information. The message type information, the transaction ID information, and the MMS version information have set values similar with the values set at the time of transmitting the request for the setting of the automatic reply message. A set value of the action information is set as the deletion. The storage position information is set based on the storage position of the automatic reply message to have to be deleted.

An operation of the MMS relay/server 30 receiving the above constructed MM1_auto_reply.REQ message from the first terminal 10 according to the present invention is illustrated in FIG. 7. FIG. 7 is a flowchart illustrating the operation of the MMS relay/server when the request for the deletion of the automatic reply message is received according to the present invention.

Referring to FIGS. 4 to 7, in Step 345 of FIG. 7, the MMS relay/server 30 checks a value of the action information element of the MM1_auto_reply.REQ message received in Step 301. If the value is the deletion, the MMS relay/server 30 determines that the automatic reply message deletion request is received, and proceeds to Step 347. If the value is not the deletion, the MMS relay/server 30 determines that an error is generated because any value of the setting, the change, the view, and the deletion is not set for the action information in the check results of Steps 303, 315, and 329, and proceeds to Step 359. In Step 359, the MMS relay/server 30 includes information representing the error in the MM1_auto_reply.RES message and transmits it to the first terminal 10, thereby transmitting the error message. In Step 347, the MMS relay/server 30 determines whether the MM1_auto_reply.REQ message includes the storage position information of the automatic reply message to be deleted. If affirmative, the MMS relay/server 30 proceeds to Step 349 and, otherwise, proceeds to Step 359. In Step 349, the MMS relay/server 30 determines whether there exists the automatic reply message to be deleted, with reference to the storage position information, and proceeds to Step 351. In Step 351, the MMS relay/server 30 deletes the searched automatic reply message, and proceeds to Step 353. In Step 353, the MMS relay/server 30 determines whether there exist other automatic reply messages to be deleted. If affirmative, the MMS relay/server 30 proceeds with to Step 349 and, otherwise, proceeds to Step 355. In Step 355, the MMS relay/server 30 determines whether all the automatic reply messages are deleted. If affirmative, the MMS relay/server 30 proceeds to Step 357 and, otherwise, proceeds to Step 359. In Step 357, the MMS relay/server 30 includes information representing deletion completion in the MM1_auto_reply.RES message, and transmits a deletion completion reply to the first terminal 10. Referring again to Step 301 of FIG. 4, the MMS relay/server 30 determines whether there is any new automatic reply request.

The setting information included in the MM1_auto_reply.RES message is message type information, transaction ID information, MMS version information, storage position information, and request result text information. The message type information, the transaction ID information, and the MMS version information are set values similar with the values set to the MM1_auto_reply.RES message at the time of the automatic reply message setting request. The storage position information is set for the storage position of the automatic reply message to be deleted and, when one or more automatic reply messages are not successfully deleted, is specified every unsuccessful deletion. The request result information, information representing a success or failure of execution for the automatic reply request, is marked one time every cause of failure. The request result text information can be also generated by several causes, and is marked one time every cause.

Still in the present invention, the mobile communication terminal can be constructed to perform some operations of the MMS relay/server 30. For example, in order to clearly include the storage position information in the MM1_auto_reply.REQ message at the time of the automatic reply message deletion request, the mobile communication terminal can be constructed to provide a guidance message of informing that the MM1_auto_reply.REQ message should necessarily include the storage position information of the automatic reply message to be deleted. The mobile communication terminal can be constructed to determine whether the MM1_auto_reply.REQ message includes the storage position information before transmission, and display an error message for the user when the MM1_auto_reply.REQ message does not include the automatic reply message.

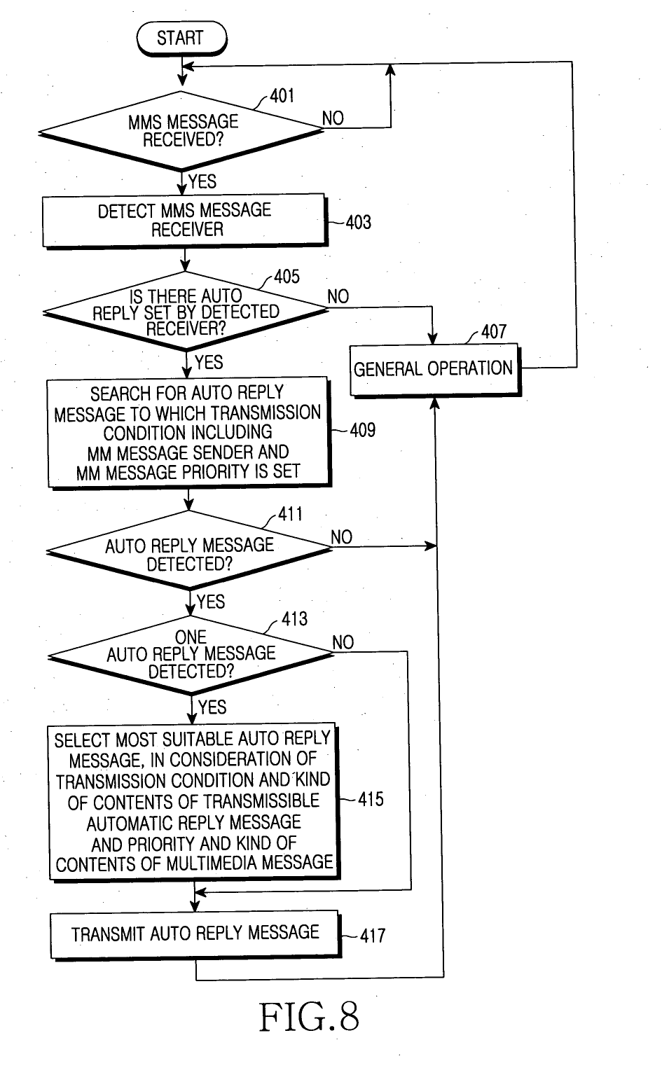

An operation of transmitting the automatic reply message set, changed, and deleted as described above in response to a predetermined multimedia message is illustrated in FIG. 8. FIG. 8 is a flowchart illustrating the operation of the MMS relay/servers 30 and 40 when the automatic reply message is transmitted according to the present invention. Referring to FIG. 8, in Step 401, the MMS relay/servers 30 and 40 determine whether they receive any new multimedia message. Upon reception, the MMS relay/servers 30 and 40 proceed to Step 403 and, otherwise, wait for the reception of a predetermined multimedia message. In Step 403, the MMS relay/servers 30 and 40 detect the receiver of the received multimedia message, and proceed to Step 405. In Step 405, the MMS relay/servers 30 and 40 determine whether there is an automatic reply set by the receiver detected in Step 403. If so, the MMS relay/servers 30 and 40 proceed to Step 409 and, otherwise, they proceed to Step 407 and perform a general operation. Simply, in Step 407, the MMS relay/servers 30 and 40 transmit a notification of informing that there is a multimedia message to be received, to the mobile communication terminal, and return to Step 401 and wait for the reception of a predetermined multimedia message. In Step 409, the MMS relay/servers 30 and 40 search for the automatic reply message by the transmission condition including the sender of the received multimedia message and the priority set to the multimedia message, and proceed to Step 411. The automatic reply message with the search condition including the sender of the received multimedia message and the priority set to the multimedia message refers to an automatic reply message that can be transmitted to the multimedia message sender. In Step 411, the MMS relay/servers 30 and 40 determine whether the automatic reply message is detected as the execution result of the Step 409. If so, the MMS relay/servers 30 and 40 proceed to Step 413 and, otherwise, proceed to Step 407. In Step 413, the MMS relay/servers 30 and 40 determine whether one automatic reply message is detected. If so, the MMS relay/servers 30 and 40 proceed with Step 417 and, if at least two (2) automatic reply messages are detected, they proceed to Step 415. In Step 415, the MMS relay/servers 30 and 40 can transmit the plurality of automatic reply messages to the multimedia message sender. Thus, the MMS relay/servers 30 and 40 select the most suitable automatic reply message, in consideration of the transmission condition and a kind of the contents of the transmissible automatic reply message and the priority and a kind of the contents of the multimedia message, and proceed to Step 417. In Step 417, the MMS relay/servers 30 and 40 transmit the selected automatic reply message to the sender of the received multimedia message, and proceed to Step 407.

The following is a basis for, in the MMS relay/servers 30 and 40, selecting the most suitable automatic reply message from the plurality of transmissible automatic reply messages in Step 415.

First, the automatic reply message having a specified set value rather than a general default value as the transmission condition is more prioritized and selected. Second, the automatic reply message is selected as information of a specific sender designated to the sender address rather than a specified set value for the priority is more prioritized.

As an example of the first basis, a case where the first terminal 10 sets three (3) automatic reply messages to have a transmission condition below will be described herein below. A first automatic reply message is in state where the second terminal 20 is set as the sender address and the priority is not designated. A second automatic reply message is in state where the sender address is not designated as an address of a specific sender and the priority is not also designated as a specific priority. A third automatic reply message is in state where a third terminal (not shown) is set as the sender address and priority is set high.

The third terminal transmitting the multimedia message with the high set priority, to the first terminal 10, first, the MMS relay/servers 30 and 40 search for three automatic reply messages related to the first terminal 10. The MMS relay/servers 30 and 40 determine whether the searched automatic reply message can be transmitted to the third terminal. In actuality, the sender of the multimedia message is the third terminal while, in the first automatic reply message, the second terminal 20 is set as the multimedia message sender. Thus, the first automatic reply message cannot be transmitted to the third terminal. The second automatic reply message cannot be transmitted to the third terminal since its transmission condition is set a predetermined mobile communication terminal and a predetermined priority. The third automatic reply message cannot be transmitted to the third terminal since its sender address is designated to the third terminal is designated and its priority is set high.

Thereafter, the MMS relay/servers 30 and 40 determine by the first basis as to whether any one of the second and third automatic reply messages is suitable in transmission in association with the multimedia message received from the third terminal, and select a suitable one. In other words, since the transmission condition set to the third automatic reply message has a specific value such as the third terminal and the high priority, the MMS relay/servers 30 and 40 determine that the third automatic reply message is more suitable than the second automatic reply message of which the transmission condition is set as a default value constituted of many and unspecified ones and unspecified priority, and transmit the third automatic reply message to the third terminal.

In case where the third terminal transmits a multimedia message with normal priority to the first terminal 10, the third automatic reply message is set by the high priority and thus, cannot have transmission qualification. Accordingly, the second automatic reply message is selected.

An example of the second basis is as follows. The second basis is considered when a predetermined multimedia message sender is consistent in its address with a specific sender address set to the automatic reply message, but a specific priority set to the multimedia message is not included in the priority set to the automatic reply message while, the priority set to the multimedia message is included in priority set to another automatic reply message, however the sender information set to the multimedia message is not consistent with sender information set to another automatic reply message. For example, it is assumed that the first terminal 10 sets the first automatic reply message with its sender address designated as the second terminal 20 and with a predetermined priority, and the second automatic reply message with its sender address set as a predetermined sender and with the high priority. The second terminal 20 transmitting the multimedia message with the high priority to the first terminal 10, the MMS relay/servers 30 and 40 search for the first and second automatic reply messages as transmissible automatic reply messages. The MMS relay/servers 30 and 40 select and transmit the first automatic reply message to the second terminal 20, according to the second basis in which the specified sender address is more prioritized than the specified priority in the transmission condition.

It is described that only one automatic reply message is set for one multimedia message sender and one priority. For example, the automatic reply message having the high priority by a predetermined multimedia message sender is set to only one. However, in the present invention, it can be also constructed that if contents of the automatic reply message are different in kind, at least one automatic reply message with the same multimedia message sender and the same priority can be set. This is because an execution capacity of the automatic reply message in the mobile communication terminal to receive the automatic reply message can be different at each terminal. For example, there can exists a mobile communication terminal that cannot play a moving picture. Accordingly, if the automatic reply message receiver receives a moving picture based on an automatic reply message, the automatic reply message receiver may feel unpleasant, and an automatic reply message sender is responsible for a transmission cost of the unplayable automatic reply message, thereby causing an economic loss. Thus, it is desirable that it is possible to set the automatic reply message having the same sender address and the same priority and comprised of a different kind of contents.

Thus, the MMS relay/servers 30 and 40 can determine the automatic reply message to be transmitted, by the type of the contents included in the transmitted multimedia message. First, the MMS relay/servers 30 and 40 employ the bases described in a description of FIG. 8, as the basis for selecting the automatic reply message to be transmitted from the plurality of transmissible automatic reply messages. An additional selection basis is as follows.

The MMS relay/servers 30 and 40 analyze the contents of the received multimedia message, and detects the type of the contents whose processing difficulty is highest among the included contents. In the present invention, the processing difficulty of the contents of a variety of type are determined high in a sequence of moving picture, image, and text. The contents included in the multimedia message are identified in its type by checking Multipurpose Internet Mail Extension (MIME) types included in the multimedia message. The MMS relay/servers 30 and 40 analyze the contents of the transmissible automatic reply message associated with the received multimedia message, detect the type of the respective included contents with highest processing difficulty, and compare the detected contents kind with the kind of the contents with the high processing difficulty extracted from the multimedia message. The MMS relay/servers 30 and 40 decide the automatic reply message with the contents type determined to be consistent in the comparison result, as the automatic reply message to be transmitted. When the contents of the decided automatic reply message cannot be played in the mobile communication terminal of the multimedia message sender, an automatic reply message having contents with lower processing difficulty than the highest processing difficulty of the contents detected from the multimedia message is selected and transmitted. For example, in case where the content with the highest processing difficulty among the contents included in a predetermined multimedia message is the image, but the automatic reply message including the image cannot be transmitted, the MMS relay/servers 30 and 40 select the automatic reply message that includes the text as the contents of the highest processing difficulty.

For example, it is assumed that the first terminal 10 sets the first automatic reply message which is constituted of the image and in which a predetermined sender address and a predetermined priority are set, the second automatic reply message which is constituted of the text and in which a predetermined sender address and a predetermined priority are set, and the third automatic reply message which is constituted of the moving picture and in which the second terminal 20 is designated as the sender address and the priority is set high. The second terminal 20 transmits the multimedia message constituted of the text and the image and having the high priority, to the first terminal 10. The MMS relay/servers 30 and 40 receive the multimedia message to be transmitted to the first terminal 10, and analyze the contents of the received multimedia message. If it is determined that the second terminal 20 does not play the moving picture, the automatic reply message transmitted to the second terminal 20 can be the first automatic reply message. Simply, the automatic reply message most suitable among the automatic reply messages related to the first terminal 10 is the third automatic reply message depending on the sender address and priority set value, but since it is determined that the second terminal 20 is impossible to play the moving picture, a finally transmitted automatic reply message can be the first automatic reply message. Therefore, the automatic reply message with the most suitable contents is most prioritized in selection.

In case where it is constructed to set the plurality of automatic reply messages with the same transmission condition depending on the kind of the contents as above, other bases considering the kind of the contents, together with the basis described in FIG. 4, are also added or modified in the basis for determining the conflict between the respective automatic reply messages at the time of setting the automatic reply message.

In other words, a basis that, if even the contents of the highest processing difficulty detected from each of the plurality of automatic reply messages with the same sender address and the same priority set are the same in kind, the plurality of automatic reply messages are in conflict with each other, is added, and other bases are identically applied.

For example, in case where the first terminal 10 sets the first automatic reply message designating the second terminal 20 as the sender address, having the high priority, and including only the image contents, and the second automatic reply message designating the third terminal as the sender address, having the high priority, and including only the image contents, the automatic reply messages are not in conflict with each other, including the contents of the same type, but being different in their transmission condition.

In another example, in case where the first terminal 10 sets the first automatic reply message designating the second terminal 20 as the sender address, having the high priority, and including only the image contents, and the second automatic reply message which includes only the image contents and in which a predetermined sender address and a predetermined priority are set, the two automatic reply messages are not in conflict with each other because the first automatic reply message is a specific case of the second automatic reply message.

In a further another example, in case where the first terminal 10 sets the first automatic reply message designating the second terminal 20 as the sender address, having the high priority, and including only the image contents, and the second automatic reply message designating the second terminal 20 as the sender address, having the high priority, and including the image contents and the moving picture contents, though the two automatic reply messages are identical in their transmission conditions with each other, the two automatic reply messages are not in conflict with each other because the contents of the highest processing difficulty included in the automatic reply messages are different in type, respectively, as the image and the moving picture.

In a still further another example, in case where the first terminal 10 sets the first automatic reply message designating the second terminal 20 as the sender address, having the high priority, and including only the image contents, and the second automatic reply message designating the second terminal 20 as the sender address, having the high priority, and including the image contents and the text contents, the two automatic reply messages are in conflict with each other because the same transmission condition is set and the contents of the highest processing difficulty included in the automatic reply messages are the same as each other in type, respectively, as the images.

Meantime, in the present invention, in the transaction between the mobile communication terminal and the MMS relay/servers 30 and 40 depending on the automatic reply message setting, changing, viewing, and deleting processes, a newly defined automatic reply transaction includes the MM1_auto_reply.REQ message and the MM1_auto_reply.RES message. However, when the storage position of the automatic reply message is the MM boxes 50 and 60, the transaction between the mobile communication terminal and the MMS relay/servers 30 and 40 depending on the automatic reply message setting, changing, viewing, and deleting processes can also be constructed to employ a conventional MM box transaction. Thus, mapping between the MM box transaction and the MM1_auto_reply.REQ message and MM1_auto_reply.RES message transaction, which is constructed depending on the automatic reply message setting, changing, viewing, and deleting processes, will be described herein below.

First, a function and a construction of the MM box transaction used for managing the messages in the MM boxes 50 and 60 are as follows.

An MM1_mmbox_store.REQ message refers to a message transmitted when the mobile communication terminal transmits to the MMS relay/servers 30 and 40 a request for successively storing a message provided at a temporary storage position of a current corresponding relay/server in the MM boxes 50 and 60. The relay/servers 30 and 40 store the multimedia message in the MM boxes 50 and 60, and respond and transmit an MM1_mmbox_store.RES message having a storage position for the stored multimedia message.

An MM1_mmbox_upload.REQ message refers to a message transmitted when the mobile communication terminal uploads the multimedia message and transmits to the MMS relay/servers 30 and 40 the request for storing the uploaded multimedia message in the MM boxes 50 and 60. The MMS relay/servers 30 and 40 store the multimedia message in the MM boxes 50 and 60, and reply by including and transmitting the storage position of the stored multimedia message in an MM1_mmbox_upload.RES message.

An MM1_mmbox_view.REQ message refers to a message transmitted when the mobile communication terminal transmits to the MMS relay/servers 30 and 40 the request for preparing multimedia message information and list for all or some of the multimedia messages currently stored in the MM boxes 50 and 60 of the request user. The MMS relay/servers 30 and 40 prepare the multimedia message list, and reply by including and transmitting a related characteristic in an MM1_mmbox_view.RES message.

An MM1_mmbox_delete.REQ message refers to a message transmitted when the mobile communication terminal transmits to the MMS relay/servers 30 and 40 the request for deleting at least one multimedia message currently stored in the MM boxes 50 and 60. The MMS relay/servers 30 and 40 transmit an MM1_mmbox_delete.RES message, and check message deletion.

The mapping between the MM box transaction and the transaction added according to the present invention is illustrated in Table 1 herein below.

TABLE 1

| Automatic reply | | |
|---|---|---|
| transaction | MM Box transaction | Description |
| MM1_auto_reply (action = | MM1_mmbox_upload | Set new |
| “set”) | | automatic |
| | | reply message |
| MM1_auto_reply (action = | MM1_mmbox_store | Change setting |
| “change”) | | of automatic |
| | | reply message |
| MM1_auto_reply (action = | MM1_mmbox_view | View setting |
| “view”) | | of automatic |
| | | reply message |
| MM1_auto_reply (action = | MM1_mmbox_delete | Delete at least |
| “delete”) | | one automatic |
| | | reply message |

Referring to the Table 1 above, the mobile communication terminal transmits the MM1_mmbox_upload.REQ message to the MMS relay/servers 30 and 40 in order to set the new automatic reply using the MM box transaction.

Mapping between the setting information included in the MM1_auto_reply.REQ message (action=setting) and setting information of the MM1_mmbox_upload.REQ message is illustrated in Table 2 herein below.

TABLE 2

| MM1_auto_reply.REQ | |
|---|---|
| (action = “set”) | MM1_mmbox_upload.REQ |
| Message type | Message type |
| Transaction ID | Transaction ID |
| MMS version | MMS version |
| Action | Not require |
| (Not require) | Automatic reply (New) |
| Sender address | Receiver address |
| Receiver address | Transmitter address |
| Priority | Priority |
| Time limit | Expiry time |

Referring to the Table 2, message type information, transaction ID information, and MMS version information have the same meaning as those of the description of FIG. 4. The MM1_mmbox_upload.REQ message does not require action information, and adds automatic reply information that is new information representing that a message to be uploaded should be used as the automatic reply message, in contrast with a standard message not having any specific function.

The sender address information of the MM1_auto_reply.REQ message corresponds to receiver address information of the MM1_mmbox_upload.REQ message. A set value of the sender address information or the receiver address information is used when it is decided whether the automatic reply message is transmitted or when it is determined whether the automatic reply message is conflict with other automatic reply messages. The receiver address of the MM1_auto_reply.REQ message corresponds to a sender address of the MM1_mmbox_upload.REQ message. The receiver address specified for the MM1_auto_reply.REQ message refers to an address of a receiver who requests for the automatic reply service, and who is a reception object of the multimedia message. Sender information of the MM1_mmbox_upload.REQ message refers to information on a sender of a message uploaded to the MM boxes 50 and 60. The receiver address information and the sender information have the same meaning.

The priority information of the MM1_auto_reply.REQ message corresponds to priority information of the MM1_mmbox_upload.REQ message. The set value of the priority information of the MM1_auto_reply.REQ message is set as the priority related to the priority of the multimedia message that induces the transmission of the automatic reply message. The priority is used for deciding whether or not the automatic reply message is transmitted and determining whether or not the automatic reply message is in conflict with other automatic reply messages.

The time limit information of the MM1_auto_reply.REQ message corresponds to expiry time information of the MM1_mmbox_upload.REQ message. The set value of the time limit information of the MM1_auto_reply.REQ message represents a period for which an automatic reply function of the automatic reply message is effective. The expiry time information of the MM1_mmbox_upload.REQ message refers to a time at which the uploaded multimedia message expires in its storage period and is deleted. The time limit information and the expiry time information can be mapped with each other, but not so. This is because the expiry of the automatic reply function does not mean that the multimedia message should be essentially deleted.

Table 3 below illustrates the mapping between elements of the setting information of the MM1_auto_reply.RES message (action=set) and the setting information of the MM1_mmbox_upload.RES message.

TABLE 3

| MM1_auto_reply.RES | |
|---|---|
| (action = “set”) | MM1_mmbox_upload.RES |
| Message type | Message type |
| Transaction ID | Transaction ID |
| MMS version | MMS version |
| Storage position | Reference |
| Request result | Request result |
| Request result text | Request result text |

Referring to the Table 3, request result information of the MM1_mmbox_upload.RES message transmitted in response to the request for the setting of the automatic reply message should include not only a check that the message is successfully uploaded, but also a check that the automatic reply function is successfully set. In error, a suitable error code should be transmitted to the mobile communication terminal, and a request result text can show an appropriate description to describe the error.

In order to change the existing automatic rely settings, the mobile communication terminal transmits the MM1_mmbox_store.REQ message of which the action information is set as the change, to the MMS relay/servers 30 and 40. Table 4 below illustrates the mapping between the setting information of the MM1_auto_reply.REQ message (action=change) and setting information of the MM1_mmbox_store.REQ message.

TABLE 4

| MM1_auto_reply.REQ | |
|---|---|
| (action = “change”) | MM1_mmbox_store.REQ |
| Message type | Message type |
| Transaction ID | Transaction ID |
| MMS version | MMS version |
| Storage position | Reference |
| Action | (Not require) |
| Sender address | Automatic reply sender |
| | address (new) |
| Priority | Automatic reply |
| | priority (new) |
| Time limit | Automatic reply time limit |
| | (new) |

Referring to the Table 4, the message type information, the transaction ID information, the MMS version information, and the storage position information have the same meaning. The MM1_mmbox_store.REQ message does not require action information, and newly adds automatic reply sender address information, automatic reply priority information, and automatic reply time limit information. The MM1_mmbox_upload.REQ message includes the information newly added to the MM1_mmbox_store.REQ message, and can name them as sender address information, priority information, and expiry time information so that they can be consistent with names of the corresponding setting information.

Table 5 below illustrates that the elements of the setting information of the MM1_auto_reply.RES message (action=change) are mapped to information elements of the MM1_mmbox_store.RES message.

TABLE 5

| MM1_auto_reply.RES | |
|---|---|
| (action = “change”) | MM1_mmbox_store.RES |
| Message type | Message type |
| Transaction ID | Transaction ID |
| MMS version | MMS version |
| Storage position | Reference |
| Request result | Storage result |
| Request result text | Storage result text |

Referring to the Table 5, a request result of the MM1_mmbox_store.RES message in response to the request for the change of the automatic reply message should include a check of a successful execution of the automatic reply related information elements and all the request changes. In error, a suitable error code should be replied to a request MMS client. Storage result text information can show an appropriate description to describe the error.

In order to view the at least one existing automatic reply message, the mobile communication terminal transmits the MM1_mmbox_view.REQ message in which a view action is set, to the MMS relay/servers 30 and 40. Table 6 below illustrates that the setting information of the MM1_auto_reply.REQ message (action=view) is mapped to setting information of the MM1_mmbox_view.REQ message.

TABLE 6

| MM1_auto_reply.REQ | |
|---|---|
| (action = “view”) | MM1_mmbox_view.REQ |
| Message type | Message type |
| Transaction ID | Transaction ID |
| MMS version | MMS version |
| Storage position | Reference |
| Action | (Not require) |
| Sender address | Automatic reply sender address |
| | (new/selection) |
| Priority | Automatic reply priority (new/selection) |
| Time limit | Automatic reply time limit (new/selection) |
| Contents | Contents of attributes list |
| (Not require) | Automatic reply sender address of attribute |
| | list (new) |
| (Not require) | Automatic reply priority of attribute list |
| | (new) |
| (Not require) | Automatic reply time limit of attribute list |
| | (new) |

Referring to the Table 6, the message type information, the transaction ID information, the MMS version information, and the storage position information have the same meaning. The MM I_mmbox_view.REQ message does not require action information. The sender address information, the priority information, and the time limit information of the MM1_auto_reply.REQ message are used as the bases for selecting the automatic reply messages matched with their values. A selection information element, which is selected by flags, previously exists in the MM1_mmbox_store.REQ message, corresponding to the three information. Thus, the three information related to the automatic reply messages can be included as additional values of the selection information element. In the present invention, the three information can be also specified as separate headers. Contents information of the MM1_mmbox_view.REQ message is the same as and the contents information of the MM1_auto_reply.REQ message. In order to receive the settings related to the automatic reply messages together in response to the display request, setting names of attributes list information of the MM1_mmbox_view.REQ message should be specified.

Table 7 below illustrates mapping between the setting information of the MM1_auto_reply.RES message in which the view action is set and setting information of the MM l_mmbox_view.RES message.

TABLE 7

| MM1_auto_reply.RES | |
|---|---|
| (action = “view”) | MM1_mmbox_view.RES |
| Message type | Message type |
| Transaction ID | Transaction ID |
| MMS version | MMS version |
| Storage position | Reference to multimedia message listing |
| Sender address | Sender address of multimedia message |
| | listing |
| Priority | Priority of multimedia message listing |
| Time limit | Time limit of multimedia message listing |
| Request result | Request result |
| Request result text | Request result text |

Referring to the Table 7, the MM1_mmbox_view.RES message provides an information element, which is a listing including groups of the information elements. Each group should include the storage position (reference value) of the automatic reply message selected by the user, and all the information elements specified for an attributes list of the MM1_mmbox_view.REQ message. Thus, the storage positions and settings of all the selected automatic reply messages can be included in the multimedia message listing information element.

In order to delete the at least one existing automatic reply message, the mobile communication terminal transmits the MM1_mmbox_delete.REQ message in which a deletion action is set, to the MMS relay/servers 30 and 40. Table 8 below illustrates mapping between the setting information of the MM1_auto_reply.REQ message (action=deletion) and setting information of the MM1_mmbox_delete.REQ message.

TABLE 8

| MM1_auto_reply.REQ | |
|---|---|
| (action = “delete”) | MM1_mmbox_delete.REQ |
| Message type | Message type |
| Transaction ID | Transaction ID |
| MMS version | MMS version |
| Storage position | Reference value |
| Action | (Not require) |

Referring to the Table 8, the message type information, the transaction ID information, the MMS version information, and the message storage position information (reference value information) have the same meaning. The MM1_mmbox_delete.REQ message does not require action information.

Table 9 below illustrates that the setting information of the MM1_auto_reply.RES message in which deletion action is set, is mapped with setting information of the MM1_mmbox_delete.RES message.

TABLE 9

| MM1_auto_reply.RES | |
|---|---|
| (action = “delete”) | MM1_mmbox_delete.RES |
| Message type | Message type |
| Transaction ID | Transaction ID |
| MMS version | MMS version |
| Storage position | Reference value |
| Request result | Request result |
| Request result text | Request result text |

Referring to the Table 9, if all the messages are successfully deleted with the message type information, the transaction ID information, and the MMS version information distinguished, just only a request result is required for informing successful deletion. If the at least one automatic reply message generate an error, they should be specified in their storage positions. A different type of errors being generated, a request result and a request result text should be also provided several times. In contrast with deletion of a standard message from the MM boxes 50 and 60, deletion of the automatic reply message means that the MMS relay/servers 30 and 40 no longer apply any automatic reply in relation to the automatic reply message.

In the present invention, the various automatic reply messages of types different from each other can be set for one multimedia message sender, or the automatic reply messages different from each other can be set depending on the sender, thereby greatly satisfying the users at both ends. The automatic reply message with the contents of the kind not suitable to the function of the terminal to receive the automatic reply message can be cutoff in its transmission, thereby increasing an economic profit. The automatic reply message suitable to the terminal function can be transmitted, thereby enhancing efficiency.

While the present invention has been shown and described with reference to a certain preferred embodiment thereof, it will be understood by those skilled in the art that various changes in form and details can be made therein without departing from the spirit and scope of the invention las defined by the appended claims.

What is claimed is:

1. A multimedia messaging (MM) automatic reply service method, comprising steps of:
in a multimedia messaging service relay/server, storing and setting an automatic reply message in response to a request for setting the automatic reply message from a predetermined mobile communication terminal, depending on a transmission condition set to the automatic reply message received from the predetermined mobile communication terminal; and
in the multimedia messaging service relay/server, upon reception of a multimedia message to be transmitted to the predetermined mobile communication terminal, comparing transmission conditions each set to at least one automatic reply message, which are set in response to the request of the predetermined mobile communication terminal, with a sender and a priority of the received multimedia message, and selecting and transmitting one automatic reply message to the multimedia message sender,
whereby, when the transmission conditions are different, at least one automatic reply message associated with one sender is set.

2. The method of claim 1, wherein the transmission condition comprises:
sender address information comprised of at least one sender address to transmit the multimedia message to the predetermined mobile communication terminal; and
priority information set to the automatic reply message depending on user's selection, and serving as a basis for determining whether the automatic reply message is transmitted, in relation to the priority of the multimedia message.

3. The method of claim 2, wherein the transmission condition further comprises:
time limit information on an automatic reply service effective period of the automatic reply message; and
address information of the predetermined mobile communication terminal that is a requester for setting the automatic reply message.

4. The method of claim 2, wherein, depending on the user's selection, the sender address information is set and specified as at least one specific sender address, or is set as a predetermined sender address whose object is many and unspecific ones.

5. The method of claim 4, wherein, depending on the user's selection, the priority information is set and specified as one or more priorities different from each other, or is set having no relation to the priority.

6. The method of claim 1, wherein the automatic reply message comprises one or more contents of a text, an image, and a moving picture.

7. The method of claim 5, wherein the step of, in the multimedia messaging service relay/server, storing and setting the automatic reply message further comprises:
receiving the request for setting the automatic reply message from the predetermined mobile communication terminal;
when the request for the automatic reply service comprises the automatic reply message, comparing the transmission condition set to the setting-requested automatic reply message, with a transmission condition of preset another automatic reply message, and determining whether they are in conflict;
when the comparison result is that they are not in conflict, storing and setting the automatic reply message depending on the transmission condition set to the automatic reply message; and
comprising a storage position of the automatic reply message in a reply to the request for the setting of the automatic reply message, and transmitting it to the predetermined mobile communication terminal.

8. The method of claim 7, wherein, when it is determined whether the setting-requested automatic reply message is in conflict, with the preset another automatic reply message, they are determined in conflict, if specific sender address information and specific priority information set to the setting-requested automatic reply message are set to the another automatic reply message.

9. The method of claim 5, wherein the step of, in the multimedia messaging service relay/server, transmitting the corresponding automatic reply message to the multimedia message sender, comprises:
upon the receipt of the multimedia message to be transmitted to the predetermined mobile communication terminal, searching for at least one automatic reply message set in response to the request of the predetermined mobile communication terminal;
comparing the transmission conditions each set to the searched automatic reply message, with the sender and the priority of the received multimedia message, and searching for the at least one automatic reply message transmissible to the multimedia message sender; and
selecting the automatic reply message to be transmitted, with the sender address information and the priority information set in the concrete and with the sender address prioritized, from the at least one automatic reply message transmissible to the multimedia message sender, and transmitting the selected message to the multimedia message sender.

10. The method of claim 5, further comprising, in the multimedia messaging service relay/server, changing the transmission condition of the automatic reply message in response to a request for change of the transmission condition of the preset automatic reply message from the predetermined mobile communication terminal.

11. The method of claim 10, wherein the step of, in the multimedia messaging service relay/server, changing the transmission condition of the automatic reply message in response to the request for the change of the transmission condition of the preset automatic reply message from the predetermined mobile communication terminal, comprises:
receiving the request for the change of the transmission condition of the at least one preset automatic reply messages from the predetermined mobile communication terminal; and
comparing a new transmission condition comprised in the transmission condition change request with a transmission condition of another automatic reply message, determining whether or not they are in conflict with each other, and, when they are determined not in conflict, changing the transmission condition of the at least one automatic reply messages positioned at the storage position comprised in the transmission condition change request message.

12. The method of claim 10, further comprising, in the multimedia messaging service relay/server, searching for the automatic reply message in response to a request for view of the preset automatic reply message from the predetermined mobile communication terminal, and providing related information to the predetermined mobile communication terminal.

13. The method of claim 12, wherein the step of, in the multimedia messaging service relay/server, searching for the automatic reply message and providing the related information to the predetermined mobile communication terminal, comprises:
receiving the request for the display of the preset automatic reply message from the predetermined mobile communication terminal;
when the automatic reply message display request comprises the storage position of the automatic reply message, detecting transmission condition information of the automatic reply message stored in the position irrespective of other transmission conditions, and comprising the detected information in a reply to the automatic reply message display request;
when the automatic reply message display request does not comprise the storage position of the automatic reply message, detecting transmission condition information of the automatic reply message to which the transmission condition comprising the transmission condition comprised in the automatic reply message display request is set, and comprising the detected information in the reply to the automatic reply message display request;
when there is a request for contents in the automatic reply message display request, comprising the contents of the automatic reply message in the automatic reply message display request reply; and
transmitting the automatic reply message display request to the predetermined mobile communication terminal.

14. The method of claim 12, further comprising, in the multimedia messaging service relay/server, searching for and deleting the at least one automatic reply messages in response to a request for deletion of the at least one automatic reply messages of the predetermined mobile communication terminal.

15. The method of claim 14, wherein the automatic reply message setting request, the request for the change of the transmission condition of the preset automatic reply message, the request for the view of the preset automatic reply message, and the request for the deletion of the automatic reply message are performed using automatic reply transaction.

16. The method of claim 15, wherein the automatic reply transaction is comprised of any one request selected, by a user of the predetermined mobile communication terminal, from the automatic reply message setting request, the request for the change of the transmission condition of the preset automatic reply message, the request for the display of the preset automatic reply message, and the request for the deletion of the automatic reply message; an MM1_auto_reply.REQ message comprising information related to the any one request; and an MM1_auto_reply.RES message corresponding to the MM1_auto_reply.REQ message and comprising an operation result of the request comprised in the MM1_auto_reply.REQ message.

17. The method of claim 16, wherein the MM1_auto_reply.REQ message comprises message type information, transaction ID (identification) information, multimedia messaging service version information, action information, sender address information, receiver address information, priority information, time limit information, and contents information, and the action information is information representing any one request selected, by the user of the predetermined mobile communication terminal, from the automatic reply message setting, transmission condition change, V and deletion requests.

18. The method of claim 16, wherein the MM1_auto_reply.RES message corresponding to the MM1_auto_reply.REQ message, which comprises any one request among the automatic reply message setting request, the request for the change of the transmission condition of the preset automatic reply message, and the request for the deletion of the preset automatic reply message, comprises message type information, transaction ID information, multimedia messaging service version information, message storage position information, request result information, and request result text information.

19. The method of claim 16, wherein the MM1_auto_reply.RES message corresponding to the MM1_auto_reply.REQ message, which comprises the request for the view of the preset automatic reply message, comprises message type information, transaction ID information, multimedia messaging service version information, message storage position information, sender address information, priority information, time limit information, request result information, and request result text information.

20. The method of claim 14, wherein the automatic reply message setting request, the request for the change of the transmission condition of the preset automatic reply message, the request for the display of the preset automatic reply message, and the request for the deletion of the automatic reply message are performed using a multimedia message box transaction.

21. The method of claim 20, wherein the automatic reply message setting request is performed using an MM1_mmbox_upload.REQ message, and an operation result for the automatic reply message setting request is transmitted using an MM1_mmbox_upload.RES message.

22. The method of claim 20, wherein the request for the change of the transmission condition of the preset automatic reply message is performed using an MM1_mmbox_store.REQ message, and an operation result for the request for the change of the transmission condition of the preset automatic reply message is transmitted using an MM1_mmbox_store.RES message.

23. The method of claim 20, wherein the request for the view of the preset automatic reply message is performed using an MM1_mmbox_view.REQ message, and an operation result of the request for the view of the preset automatic reply message is transmitted using an MM1_mmbox_view.RES message.

24. The method of claim 20, wherein the request for the deletion of the preset automatic reply message is performed using an MM1_mmbox_delete.RES message, and an operation result of the request for the deletion of the preset automatic reply message is transmitted using an MM1_mmbox_delete.RES message.

25. A multimedia messaging automatic reply service method, comprising steps of:
in a multimedia messaging service relay/server, storing and setting an automatic reply message depending on a transmission condition set to the automatic reply message received from a predetermined mobile communication terminal, and a kind of contents comprised in the automatic reply message, in response to a request for setting the automatic reply message from the predetermined mobile communication terminal; and
in the multimedia messaging service relay/server, upon reception of a multimedia message to be transmitted to the predetermined mobile communication terminal, comparing transmission conditions each set to at least one automatic reply message set in response to the request of the predetermined mobile communication terminal and a kind of contents comprised therein, with a sender and a priority of the received multimedia message and a kind of contents comprised therein, and selecting and transmitting one automatic reply message to the multimedia message sender,
whereby, when the transmission conditions are different, at least one automatic reply message associated with one sender is set.

26. The method of claim 25, wherein the transmission condition comprises:
sender address information comprised of at least one sender address to transmit the multimedia message to the predetermined mobile communication terminal; and
priority information set to the automatic reply message depending on user's selection and serving as a basis for determining whether the automatic reply message is transmitted, in relation to the priority of the multimedia message.

27. The method of claim 26, wherein the transmission condition further comprises:
time limit information on an automatic reply service effective period of the automatic reply message; and
address information of the predetermined mobile communication terminal that is a requester for setting the automatic reply message.

28. The method of claim 27, wherein, depending on the user's selection, the sender address information is set and specified as at least one specific sender addressee, or is set as a predetermined sender address whose object is many and unspecific ones.

29. The method of claim 28, wherein, depending on the user's selection, the priority information is set and specified as one or more priorities different from each other, or is set having no relation to the priority.

30. The method of claim 25, wherein the automatic reply message comprises one or more contents of a text, an image, and a moving picture.

31. The method of claim 29, wherein the step of, in the multimedia messaging service relay/server, storing and setting the automatic reply message comprises:
receiving the request for setting the automatic reply message from the predetermined mobile communication terminal;
when the request for the automatic reply service comprises the automatic reply message, comparing the transmission condition set to the setting-requested automatic reply message and the kind of the contents comprised therein, with a transmission condition of preset another automatic reply message and a kind of contents comprised therein, and determining whether they are in conflict;
when the comparison result is that they are not in conflict, storing and setting the automatic reply message depending on the transmission condition set to the automatic reply message; and
comprising a storage position of the automatic reply message in a reply to the request for the setting of the automatic reply message, and transmitting it to the predetermined mobile communication terminal.

32. The method of claim 31, wherein, when it is determined whether the setting-requested automatic reply message is in conflict with the preset another automatic reply message, they are determined in conflict if contents with highest processing difficulty among the contents comprised in the automatic reply messages are the same in type as each other, and sender address information and priority information comprising specific sender address information and specific priority information set to the setting-requested automatic reply message are set to the another automatic reply message.

33. The method of claim 29, wherein the step of, in the multimedia messaging service relay/server, transmitting the corresponding automatic reply message to the multimedia message sender, comprises:
upon the reception of the multimedia message to be transmitted to the predetermined mobile communication terminal, searching the at least automatic reply message set in response to the request of the predetermined mobile communication terminal, for the automatic reply messages in which the contents of the same kind as the contents with the highest processing difficulty among the contents comprised in the received multimedia message are detected as the contents with the highest processing difficulty;
comparing the transmission conditions each set to the searched automatic reply messages with the sender and the priority of the received multimedia message, and searching for the at least one automatic reply message transmissible to the multimedia message sender; and
selecting the automatic reply message to be transmitted, with the sender address information and the priority information set in the concrete and with the sender address prioritized, from the at least one automatic reply messages transmissible to the multimedia message sender, and transmitting the selected message to the multimedia message sender.

34. The method of claim 33, wherein the processing difficulty is grasped by checking an Multipurpose Internet Mail Extension (MIME) type comprised in the multimedia message.

35. A multimedia messaging automatic reply service system, comprising:
a mobile communication terminal for transmitting an automatic reply message and its transmission condition, and transmitting a request for setting the automatic reply message; and
a multimedia messaging service relay/server for, in response to the request for setting the automatic reply message from the mobile communication terminal, storing and setting the automatic reply message depending on the transmission condition set to the automatic reply message received from the mobile communication terminal, and, upon reception of a multimedia message to be transmitted to the mobile communication terminal, comparing transmission conditions each set to at least one automatic reply message set in response to the request of the mobile communication terminal, with a sender and a priority of the received multimedia message, and selecting and transmitting one automatic reply message to the multimedia message sender,
whereby, when the transmission conditions are different, at least one automatic reply message associated with one sender is set.

36. The system of claim 35, wherein the transmission condition comprises:
sender address information comprised of at least one sender addressee to transmit the multimedia message to the mobile communication terminal; and
priority information set to the automatic reply message depending on user's selection and serving as a basis for determining whether the automatic reply message is transmitted, in relation to the priority of the multimedia message.

37. The system of claim 36, wherein the transmission condition further comprises:
time limit information on an automatic reply service effective period of the automatic reply message; and
address information of the mobile communication terminal that is a requester for setting the automatic reply message.

38. The system of claim 36, wherein, depending on the user's selection, the sender address information is set and specified as at least one specific sender address, or is set as a predetermined sender address whose object is many and unspecific ones.

39. The system of claim 38, wherein, depending on the user's selection, the priority information is set and specified as one or more priorities different from each other, or is set having no relation to the priority.

40. The system of claim 36, wherein the automatic reply message comprises one or more contents of a text, an image, and a moving picture.

41. The system of claim 39, wherein, when the request for setting the automatic reply message received from the mobile communication terminal comprises the automatic reply message, the multimedia messaging service relay/server compares the transmission condition set to the setting-requested automatic reply message with a transmission condition of preset another automatic reply message and determines whether they are in conflict, and, when the comparison result is that they are not in conflict, stores and sets the automatic reply message depending on the transmission condition set to the automatic reply message, and comprises a storage position of the automatic reply message in a reply to the request for the setting of the automatic reply message and transmits it to the mobile communication terminal.

42. The system of claim 41, wherein, when it is determined whether the setting-requested automatic reply message is in conflict with the preset another automatic reply message, the multimedia messaging service relay/server determines that they are in conflict if sender address information and priority information comprising specific sender address information and specific priority information set to the setting-requested automatic reply message are set to the another automatic reply message.

43. The system of claim 39, wherein, upon the reception of the multimedia message to be transmitted to the mobile communication terminal, the multimedia messaging service relay/server searches for at least one automatic reply message set in response to the request of the mobile communication terminal, compares the transmission conditions each set to the searched at least one automatic reply message with the sender and the priority of the received multimedia message and searches for at least one automatic reply message transmissible to the multimedia message sender, selects the automatic reply message to be transmitted, with the sender address information and the priority information set in the concrete and with the sender address prioritized, from the at least one automatic reply message transmissible to the multimedia message sender, and transmits the selected message to the multimedia message sender.

44. The system of claim 39, wherein, in response to a request for change of the transmission condition of the preset automatic reply message from the mobile communication terminal, the multimedia messaging service relay/server changes the transmission condition of the automatic reply message.

45. The system of claim 44, wherein the multimedia messaging service relay/server compares a new transmission condition, which is comprised in the request for the change of the transmission conditions of the at least one preset automatic reply message received from the mobile communication terminal, with a transmission condition of another automatic reply message, and determines whether they are in conflict, and, if they are determined not in conflict, changes the transmission condition of the at least one automatic reply message positioned at the storage position comprised in the transmission condition change request message.

46. The system of claim 39, wherein, in response to a request for display of the preset automatic reply message from the mobile communication terminal, the multimedia messaging service relay/server searches for the automatic reply message and provides related information to the mobile communication terminal.

47. The system of claim 46, wherein, when the request for the display of the preset automatic reply message received from the mobile communication terminal comprises the storage position of the automatic reply message, the multimedia messaging service relay/server detects transmission condition information of the automatic reply message stored in the position irrespective of other transmission conditions and comprises the detected information in a reply to the automatic reply message display request, and, when the automatic reply message display request does not comprise the storage position of the automatic reply message, detects transmission condition information of the automatic reply message to which the transmission condition comprising the transmission condition comprised in the automatic reply message display request is set, and comprises the detected information in the automatic reply message display request reply, and, when there is a request for contents in the automatic reply message display request, comprises the contents of the automatic reply message in the automatic reply message view request reply and transmits the automatic reply message view request to the mobile communication terminal.

48. The system of claim 39, wherein, in response to a request for deletion of the at least one automatic reply message of the mobile communication terminal, the multimedia messaging service relay/server searches for and deletes the at least one automatic reply message.

49. The system of claim 39, wherein, before transmitting the request for setting the automatic reply message, the mobile communication terminal determines whether the automatic reply message setting request comprises the automatic reply message, and, if not comprising, displays an error message, and stores all the automatic reply message transmission conditions successfully set up to now, and determines whether the transmission condition comprised in the automatic reply message setting request is in conflict with a transmission condition of an existing automatic reply message, and, if the conflict is detected, provides an error message to the user, and stops the request.

50. The system of claim 39, wherein, when there is the request for the change of the transmission condition of the preset predetermined automatic reply message from the user, the mobile communication terminal provides a message of guiding that the transmission condition change request essentially comprises position information of the predetermined automatic reply message, and determines whether the transmission condition change request comprises the storage position of the predetermined automatic reply message, and, if not comprising, provides an error message, and stores the transmission conditions of all the successfully set automatic reply messages, and determines whether or not they are in conflict with the transmission condition comprised in the transmission condition change request, and, if the conflict is detected, provides the error message and stops the request.

51. The system of claim 39, wherein the mobile communication terminal stores the transmission conditions of all the successfully set automatic reply messages, and, when there is a request for display of the predetermined automatic reply message from the user, provides set values of the automatic reply message satisfying a search basis comprised in the request for the display of the automatic reply message, and, when there is a request for contents of the automatic reply message from the user, transmits to the multimedia messaging service relay/server a request for searching for the automatic reply message contents.

52. The system of claim 39, wherein, when there is a request for deletion of the predetermined automatic reply message from the user, the mobile communication terminal provides a message of guiding that storage position information of the automatic reply message to be deleted should be essentially comprised, and determines whether the request for the deletion of the automatic reply message comprises the storage position information of the automatic reply message to be deleted, and, if not comprising, guiding an error message to the user and stopping the request.

53. A multimedia messaging automatic reply service system, comprising:
a mobile communication terminal for transmitting an automatic reply message and a transmission condition, and transmitting a request for setting the automatic reply message; and
a multimedia messaging service relay/server for, in response to the request for setting the automatic reply message from the mobile communication terminal, storing and setting the automatic reply message depending on a transmission condition set to the automatic reply message received from the mobile communication terminal and a kind of contents comprised in the automatic reply message, and, upon reception of a multimedia message to be transmitted to the mobile communication terminal, comparing transmission conditions each set to at least one automatic reply message set in response to the request of the mobile communication terminal and a kind of contents comprised therein, with a sender and a priority of the received multimedia message and a kind of contents comprised therein, and selecting and transmitting one automatic reply message to the multimedia message sender, whereby, when the transmission condition and the contents kind are different, at least one automatic reply message associated with one sender is set.
